(19) United States
(12) Patent Application Publication
(10) Pub. No.: US 2008/0292393 A1
(43) Pub. Date: Nov. 27, 2008

(54) PLASTIC SEMI-PERMANENT RETAINER RING

(75) Inventor: Mark Gilley, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 11/752,687

(22) Filed: May 23, 2007

(51) Int. Cl. F16B 4/00

(52) U.S. Cl. 403/273

(57) ABSTRACT

A semi-permanent retainer mechanism for securing a shaft within a component by forming a semi-permanent ridge on the shaft is provided. The mechanism includes a ring made from a heat shrinkable polymer that will heat shrink into a radial groove on the shaft. The heat shrinkable polymer of the ring has a release temperature wherein the ring shrinks in size when heated to a temperature above the release temperature. The ring has a pre-release size that is larger than the radial groove and a release size that is smaller than the outer circumference of the shaft.

### FIELD OF THE INVENTION

This invention relates generally to a retainer ring. More specifically, the invention relates to a semi-permanent plastic retainer ring.

### BACKGROUND OF THE INVENTION

Fastener and/or retainer mechanisms are used in a variety of applications and industries in order to prevent undesired movement of a component. If the component is located on a shaft, bar, rod and the like, undesired lateral movement of the component can result in significant damage to surrounding articles, structures and the like.

One type of fastener that can be used on a shaft is a circlip, also known as a snap ring, which consists of a semi-flexible metal ring with open ends which can be snapped into place within a machined groove of the shaft. The snap ring allows rotation of a part on the shaft but prevents lateral movement. Although useful, the snap ring requires a metal stamping operation which increases the cost of the component. In addition, failure of the snap ring during service can result in metal fragments, for example within a gear transmission, that can cause damage, wear, etc. to surrounding components.

Another type of fastener that can be used on a shaft is a cotter pin. The cotter pin is a metal fastener with two tines that are bent during installation. Typically made from a wire with a half-circular cross section, cotter pins are made of very soft metal and can be subject to metal fatigue. Thus, similar to snap rings, failure of the metal wire can result in damage, wear, etc. to surrounding components.

Other methods for securing articles and/or components on a shaft are well known in the art, for example the use of a nut in combination with threads on the shaft. In addition, a washer or plate type structure can be welded onto the shaft in order to prevent undesirable movement of components thereon. However, these securement mechanisms are relatively permanent in nature and do not lend themselves for use when repair of such an article may be needed. Therefore, there is a need for an improved semi-permanent retainer mechanism.

### SUMMARY OF THE INVENTION

A semi-permanent retainer mechanism for securing a shaft within a component by forming a semi-permanent ridge on the shaft is provided. The mechanism includes a ring made from a heat shrinkable polymer that will heat shrink into a radial groove on the shaft. The heat shrinkable polymer of the ring has a release temperature wherein the ring shrinks in size when heated to a temperature above the release temperature. The ring has a pre-release size that is larger than the radial groove and a release size that is smaller than the outer circumference of the shaft.

In an embodiment of the present invention, a shaft is cylindrical in shape and a radial groove on the shaft has an inner diameter. In this embodiment, the ring is circular in shape and has a release inner diameter that is less than the radial groove inner diameter. Once placed onto the shaft and the radial groove, heating of the ring above the release temperature results in ring shrinkage such that the ring inner diameter and the radial groove inner diameter are in contact with each other. Therefore part of the heat shrinkable polymer ring is within the radial groove of the shaft and part of the ring extends beyond the radial groove. The plastic ring can be removed by cutting the ring with a sharp object and/or prying it off of the shaft with a lever device such as a screw driver. In this manner a semi-permanent retainer mechanism in the form of a securement ridge is formed on the shaft. The present invention also includes a method for forming the securement ridge on the shaft.

### BRIEF DESCRIPTION OF THE DRAWINGS

FIG. 1 is a perspective view of an embodiment of the present invention;

FIG. 2 is a side cross-sectional view of the embodiment shown in FIG. 1;

FIG. 3 is a perspective view of the embodiment shown in FIG. 1 wherein a semi-permanent plastic retainer ring is in place;

FIG. 4 is a perspective view of the embodiment shown in FIG. 3 wherein a heat source applying heat to the semi-permanent plastic retainer ring is shown;

FIG. 5 is an end cross-sectional view of section 5-5 shown in FIG. 2;

FIG. 6 is a perspective view illustrating the removal of the semi-permanent plastic retainer ring;

FIG. 7 is a perspective view of a different embodiment of the present invention;

FIG. 8 is a side cross-sectional view of the embodiment shown in FIG. 7;

FIG. 9 is a perspective view of the embodiment shown in FIG. 7 wherein a semi-permanent plastic retainer ring is in place;

FIG. 10 is a perspective view of the embodiment shown in FIG. 7 wherein a heat source applying heat to the semi-permanent plastic retainer ring is shown;

FIG. 11 is an end cross-sectional view of section 11-11 in FIG. 8; and

FIG. 12 is a perspective view illustrating the removal of the semi-permanent plastic retainer ring.

### DETAILED DESCRIPTION OF THE PREFERRED EMBODIMENTS

The present invention discloses a semi-permanent retainer mechanism in the form of a simple to use plastic retainer ring that prevents undesirable lateral movement of a component on a shaft. As such, the present invention has utility as a retainer ring used to prevent unwanted removal and/or movement of components on a shaft.

The semi-permanent plastic retainer ring of the present invention is made from a heat shrinkable polymer. The ring can include a generally axially oriented split separation which affords for the opening and/or expanding of the ring and subsequent placement onto a shaft. Once placed onto the shaft, the ring can be heated above a release temperature of the heat shrinkable polymer and allowed to shrink onto the shaft. Shrinking of the ring onto the shaft provides a circumferential ridge which can prevent lateral movement of a component on the shaft.

Referring now to FIGS. 1-3, an embodiment of the present invention is shown wherein a shaft 100 with a diameter 110 has a radial groove 120. The radial groove 120 has an inner surface 122 with sidewalls 123 forming a U-shaped depression. The radial groove 120 has an inner diameter (ID) 115 defining a predetermined depth of groove 120. Also illustrated in the figures is a ring 200 with a generally axially oriented separation 210 and sidewalls 225 adjoining an inner diameter surface 220 to an outer diameter (OD) surface 230.

The ring 200, having a thickness in the radial direction and a width in the axial direction, is made from a heat shrinkable polymer which affords for the shrinking of the ring when heated. The heat shrinkable polymers used in the present invention have a release temperature which is defined as the temperature above which the polymer shrinks. The ring 200 has a pre-release inner diameter 222 defined as the diameter of the ring before being heated above the release temperature of the ring, that is, the ID in the pre-shrunk condition. The ring 200 also has a release inner diameter (not shown) which is defined as the inner diameter of the ring after being heated in free space above the release temperature of the polymer, that is, the ID in the post-shrunk condition. The ring 200 can be made from any heat shrinkable polymer known to those skilled in the art, illustratively including fluorinated ethylene propylene (FEP), polytetrafluoroethylene (PTFE), polyolefin, polyvinylchloride (PVC), polyvinylidene fluoride (PVDF) and combinations thereof. The release temperature of a heat shrinkable polymer used in the present invention can range from approximately 100 to 300 degrees centigrade. It is appreciated that the heat shrinkable polymer used to make a semi-permanent plastic ring of the present invention is chosen based on design factors and requirements of a particular application. It is also appreciated that the ring cross-section can be any shape, illustratively including a square, round-corner square, rectangle, round-corner rectangle, circle, hexagon and the like.

In an example of the present embodiment, the prerelease ID 222 of the ring 200 is approximately equal to the diameter 110 of the shaft 100. For the purposes of the present invention, the term “approximately equal to” is defined to mean of equal dimension within a tolerance of +25%. In another example of the present invention, the pre-release ID 222 of the ring 200 is less than the diameter 110 of the shaft 100 and greater than the ID 115 of the radial groove 120.

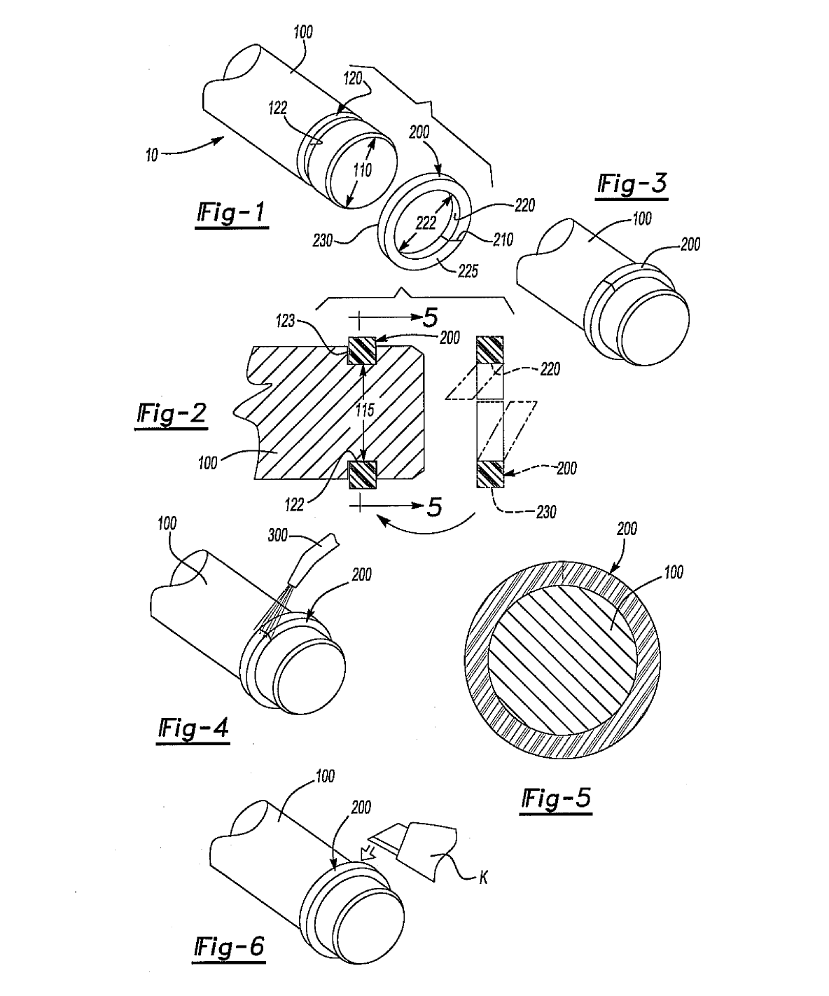

As illustrated in FIGS. 2 and 3, the separation 210 affords for opening and/or expansion of the ring 200, thereby allowing for the placement of the ring onto the shaft 100. In the alternative, a ring 200 does not have a separation 210. The ring 200 can be placed proximate to the radial groove 120 and can be at least partially within groove 120. Once properly located on the shaft 100, the ring 200 can have heat applied thereto using a heat source 300 as shown in FIG. 4. Upon heating the heat shrinkable polymer of ring 200 above its release temperature, shrinking of the polymer occurs and the ring 200 shrinks within the radial groove 120. After shrinkage has occurred, the post-release ring 200 has a thickness that is greater than the predetermined depth of the radial groove such that at least part of the post-release ring 200 is located within the radial groove 120 and at least part of the post-release ring extends beyond the groove.

In an example, heating the ring 200 above its release temperature results in shrinkage of the ring 200 such that the ID surface 220 is in contact with the radial groove inner surface 122. In another example, heating of the ring 200 above its release temperature results in shrinkage such that the ID surface 220 is not in contact with the radial groove inner surface 122 but has a post-shrunk diameter less than the shaft diameter 110. Therefore, the post-release ring 200 provides a retainer ring in the form of a circumferential ridge along the outer circumference 110 of the shaft 100. Turning now to FIG. 6, a knife IC is shown and can afford for the cutting of the ring 200 and its subsequent removal from the shaft 100. In this manner, a semi-permanent plastic retainer ring is provided to prevent undesirable lateral movement of a component on a shaft.

Although FIGS. 1-6 illustrate a shaft with a cylindrical shape, this is not required. In addition, a radial groove 120 is not required and the ring 200 can provide a retainer ring on the shaft by simply shrinking onto the shaft 100. It is appreciated that if a radial groove 120 is provided, the pre-release ring 200 can be dimensioned such that it will fit at least partially within the groove 120, or in the alternative the pre-release ring 200 can be dimensioned such that it will not fit at least partially within the groove 120 before being heated above the release temperature.

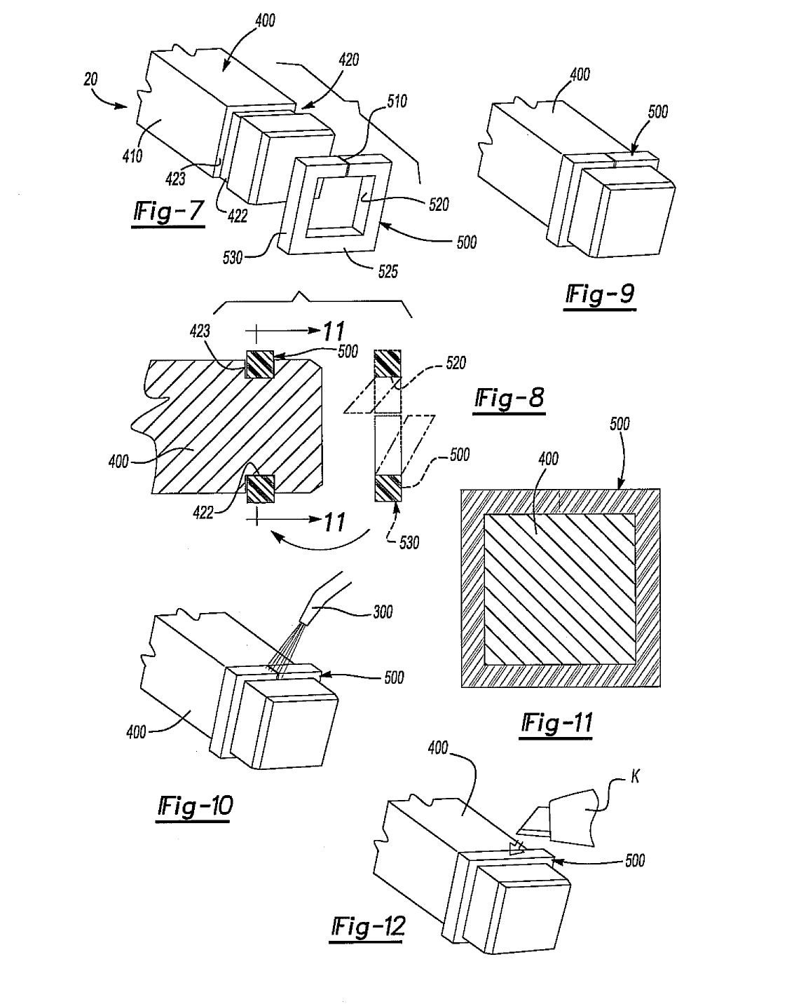

Turning now to FIGS. 7-12, a non-cylindrical shaft is illustrated at 400 with a radial groove 420 is shown. The shaft 400 has an outer circumference 410 and the groove 420 has a bottom surface 422 with sidewalls 423 defining a predetermined depth of groove 420.

A ring 500 has a shape generally matching the end cross-sectional shape of the shaft 400 and includes sidewalls 525 adjoining an inner circumference surface 520 to an outer circumference surface 530. Optionally, a generally axially oriented separation 510 can be included within ring 500. Similar to the embodiment shown in FIGS. 1-6, the ring 500 can be opened and/or expanded using the separation 510 and placed onto the shaft 400. Upon placing the pre-release ring 500 onto the shaft 400 and the radial groove 420, applying heat using the heat source 300 can result in the ring 500 shrinking at least partially within the radial groove 420. The dimensions of the post-release ring 500 are such that at least part of the ring extends beyond the radial groove 420 and thereby affords a circumferential ridge along the outer circumference of the shaft. In an example of the present embodiment, the inner surface 520 of the post-release ring 500 is within the groove 420 but not in contact with the bottom surface 422 after shrinkage of the ring 500 occurs. In another example of the present embodiment, the pre-release ring 500 shrinks after being heated such that the inner surface 520 is in contact with the bottom surface 422 of the radial groove 420.

The semi-permanent plastic retainer ring described above can be used as part of a semi-permanent retainer mechanism that affords for the desired securement of a component on the shaft. For example, components such as gears are commonly located on a shaft wherein lateral movement of the gears along the shaft is undesirable. Using the semi-permanent retainer mechanism of the present invention, a gear is placed onto the shaft, the shaft optionally having a radial groove therein, followed by placement of the retainer ring. Thereafter, a heat source applies heat to the ring and thereby raises the temperature of the ring material above the release temperature of the heat shrinkable polymer. After reaching the release temperature, the ring shrinks and forms a circumferential ridge along the outer circumference of the shaft. Once in place, the gear on the shaft can rotate about the shaft, if desired, but undesirable lateral movement is prevented. If removal of the gear from the shaft is desired, a knife or lever mechanism can be used to remove the ring and thereby allow the gear to be removed also.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

I claim:

1. A method for forming a securement ridge on a shaft by attaching a heat shrinkable polymer ring to the shaft, said method comprising the steps of:
providing a shaft with a radial groove, the radial groove having a predetermined depth;
forming a ridge forming device having:
a ring with a separation, the ring being made from a heat shrinkable polymer;
placing the ring on the shaft and at least partially within the shaft radial groove; and
heating the ring to an elevated temperature using a heat source so that the ring shrinks so that the ring is attached to the shaft, the attached ring having a width greater than the predetermined depth of the radial groove so that part of the ring is within the radial groove and part of the ring extends beyond the radial groove and forms a securement ridge on the shaft.

2. The method of claim 1, wherein the ring made from a heat shrinkable polymer has a release temperature, the ring shrinking to the second small when heated above the release temperature.

3. The method of claim 2, wherein the ring has an inner surface in contact with a bottom surface of the radial groove after the ring is heated above the release temperature.

4. The method of claim 1, wherein the release temperature is above 100° C.

5. The method of claim 1, wherein the shaft is cylindrical in shape with a diameter, the radial groove of the shaft having an inner diameter.

6. The method of claim 5, wherein the ring is circular in shape.

7. The method of claim 6, wherein the ring has a release inner diameter that is less than the radial groove inner diameter.

8. The method of claim 1, wherein the shaft is a shaft used in a motor vehicle.

9. The method of claim 8, wherein the shaft has a gear thereon and the ring prevents the gear from sliding off the shaft.

10. A part retainer assembly for positioning a part on, said assembly comprising:
a shaft with an outer surface and a radial groove having a predetermined depth;
a ring having an generally axially oriented separation and made from a heat shrinkable polymer, said ring having a pre-determined width larger than said predetermined depth of said radial groove;
said heat shrinkable polymer having a release temperature and operable to shrink in size when heated to a temperature above said release temperature; and
said ring having a release width larger than said predetermined depth of said radial groove smaller than said shaft outer circumference and operable to shrink at least partially within said radial groove when placed onto said radial groove of said shaft and heated to a temperature above said release temperature.

11. The invention of claim 11, wherein said shaft is cylindrical in shape, said radial groove having an inner diameter.

12. The invention of claim 11, wherein said ring is circular in shape.

13. The invention of claim 12, wherein said ring has a release inner diameter less than said radial groove inner diameter.

14. The invention of claim 13, wherein said ring inner diameter shrinks to said radial groove inner diameter when said ring is placed onto said radial groove and heated to a temperature greater than said release temperature.

15. The invention of claim 11, wherein said release temperature is above 100° C.

16. The invention of claim 11, wherein said shaft is a motor vehicle shaft.

17. The invention of claim 11, further comprising a gear on said shaft, said ring preventing said gear from sliding off said shaft.

18. The invention of claim 17, wherein said shaft is a motor vehicle shaft with a gear thereon.

19. The invention of claim 18, wherein said motor vehicle shaft is a shaft in a transmission of said motor vehicle.
